(19) United States
(12) Patent Application Publication
(10) Pub. No.: US 2026/0349576 A1
(43) Pub. Date: Nov. 5, 2026

(54) DATA PROCESSING METHOD AND ELECTRONIC DEVICE

(71) Applicant: Lenovo (Beijing) Limited, Beijing (CN)

(72) Inventors: Yongfeng ZHANG, Beijing (CN); Di XIAO, Beijing (CN)

(21) Appl. No.: 19/660,152

(22) Filed: Apr. 27, 2026

(30) Foreign Application Priority Data
Apr. 30, 2025 (CN) 202510573901.8

(51) Int. Cl. G06F 3/0481; G06F 3/04842; G06F 3/0488; G06F 3/0354

(52) U.S. Cl. CPC G06F 3/0481; G06F 3/04842; G06F 3/0488; G06F 3/03545

(57) ABSTRACT

A data processing method includes switching, in response to a target trigger event, an electronic device from a first operation mode to a second operation mode. A first application is used to receive and process first input information in the first operation mode. The method further includes, in the second operation mode, using a second application to receive second input information, inputting task information corresponding to the second input information into a target model, and receiving processing result information corresponding to the task information from the target model. The first input information and the second input information characterize input information related to an operation interface of the first application.

### CROSS-REFERENCE TO RELATED APPLICATION

This application claims priority to Chinese Patent Application No. 202510573901.8, filed on Apr. 30, 2025, the entire contents of which are incorporated herein by reference.

### TECHNICAL FIELD

The present disclosure generally relates to the field of computer technologies for power supplies, and, more particularly, to a data processing method an electronic device.

### BACKGROUND

Nowadays, applications installed on electronic devices can provide various types of information, such as text, images, videos, or audio. Users expect to be able to further process information of interest, such as saving text, images, videos, or audio locally, or enhancing images, in a simple and efficient manner.

### SUMMARY

In accordance with the disclosure, there is provided a data processing method including switching, in response to a target trigger event, an electronic device from a first operation mode to a second operation mode. A first application is used to receive and process first input information in the first operation mode. The method further includes, in the second operation mode, using a second application to receive second input information, inputting task information corresponding to the second input information into a target model, and receiving processing result information corresponding to the task information from the target model. The first input information and the second input information characterize input information related to an operation interface of the first application.

Also in accordance with the disclosure, there is provided an electronic device including a processor and a display screen. The processor is configured to switch, in response to a target trigger event, the electronic device from a first operation mode to a second operation mode. In the first operation mode, a first application is used to receive and process first input information. The processor is further configured to, in the second operation mode, use a second application to receive second input information, input task information corresponding to the second input information into a target model, and receive processing result information corresponding to the task information from the target model. The first input information and the second input information characterize input information related to an operation interface of the first application. The display screen is configured to display the processing result information.

Also in accordance with the disclosure, there is provided a non-transitory computer-readable storage medium storing instructions that, when executed by a processor, cause an electronic device including the processor to switch, in response to a target trigger event, from a first operation mode to a second operation mode. In the first operation mode, a first application is used to receive and process first input information. The instructions, when executed by a processor, further cause the electronic device to, in the second operation mode, use a second application to receive second input information, input task information corresponding to the second input information into a target model, and receive processing result information corresponding to the task information from the target model. The first input information and the second input information characterize input information related to an operation interface of the first application. The display screen is configured to display the processing result information.

### BRIEF DESCRIPTION OF THE DRAWINGS

FIG. 1 is a flow chart of a data processing method consistent with embodiments of the present disclosure.

FIG. 2 is a schematic diagram showing an embodiment of the present disclosure.

FIG. 3 is schematic diagram showing another embodiment of the present disclosure.

FIG. 4 is schematic diagram showing another embodiment of the present disclosure.

FIG. 5 is a schematic structural diagram of a data processing apparatus consistent with embodiments of the present disclosure.

FIG. 6 is a schematic hardware diagram of an electronic device consistent with embodiments of the present disclosure.

### DETAILED DESCRIPTION OF THE EMBODIMENTS

Various schemes and features of the present disclosure are described herein with reference to the accompanying drawings. The embodiments in the present disclosure are only used to describe the present disclosure and are not intended to limit the scope of the present disclosure. It is understandable that other embodiments obtained by those skilled in the art in the absence of inventive effort are within the scope of the present disclosure. In the following detailed description, numerous specific details are set forth to provide a thorough understanding of the embodiments of the present disclosure for ease of explanation. However, it will be apparent that one or more embodiments may be implemented without these specific details. Furthermore, descriptions of well-known structures and technologies are omitted in the following description to avoid unnecessarily obscuring the concepts of the present disclosure.

In the following description, references are made to “some embodiments,” which describe a subset of all possible embodiments of the present disclosure. However, it is to be understood that “some embodiments” may refer to the same subset or different subsets of all possible embodiments, and may be combined with one another without conflict.

The terms “first,” “second,” “third,” and the like used herein serve merely to distinguish between similar objects and do not represent a specific ordering of those objects. It is to be understood that, where permissible, “first,” “second,” “third,” and the like may be interchanged in terms of specific order or sequence, thereby allowing the embodiments of the present disclosure described herein to be implemented in an order other than that illustrated or described herein.

Unless otherwise defined, all technical and scientific terms used herein shall have the same meaning as is commonly understood by those skilled in the art to which the present disclosure pertains. The terminology used herein is for the purpose of describing the present disclosure only and is not intended to be limited thereof.

As mentioned above, regarding application information presented by an application, users often need to perform further processing on specific information of interest. However, some applications do not support local processing of application information by the users, or the steps required to perform such local processing are relatively complex.

For example, in a scenario where an application does not support saving images locally, a user needs to first capture a screenshot on the electronic device and then use image editing software to crop a specific image of interest from that screenshot. This approach involves a lengthy operational workflow. Furthermore, the cropped image extracted from the screenshot typically has a lower resolution and cannot match the quality of the original image.

For another example, in a scenario where an application supports saving images locally and the user wishes to perform further editing on a specific image of interest, the user needs to first save the image locally, then import the locally saved image into image editing software for editing, and finally save the edited image locally once again. This approach also suffers from the drawbacks of a lengthy and cumbersome operational workflow. Further, some image editing software requires a paid subscription, resulting in incurring additional costs for image editing services to the user.

The present disclosure provides a data processing method, to at least partially alleviate the above problems. The data processing method may be executed by an electronic device. The electronic device may be various types of terminals, such as a laptop computer, tablet computer, desktop computer, tv box, or mobile device (e.g., a mobile phone, portable music player, personal digital assistant, dedicated messaging device, or portable gaming device), or may alternatively be implemented as a server. The server may be a standalone physical server, a server cluster, a distributed system including multiple physical servers, or a cloud server providing foundational cloud computing services (such as cloud services, cloud databases, cloud computing, cloud functions, cloud storage, network services, cloud communication, middleware services, domain name services, security services, Content Delivery Networks (CDN), big data or artificial intelligence platforms).

Hereinafter, the technical solutions set forth in the embodiments of the present disclosure will be clearly and completely described with reference to the accompanying drawings of said embodiments.

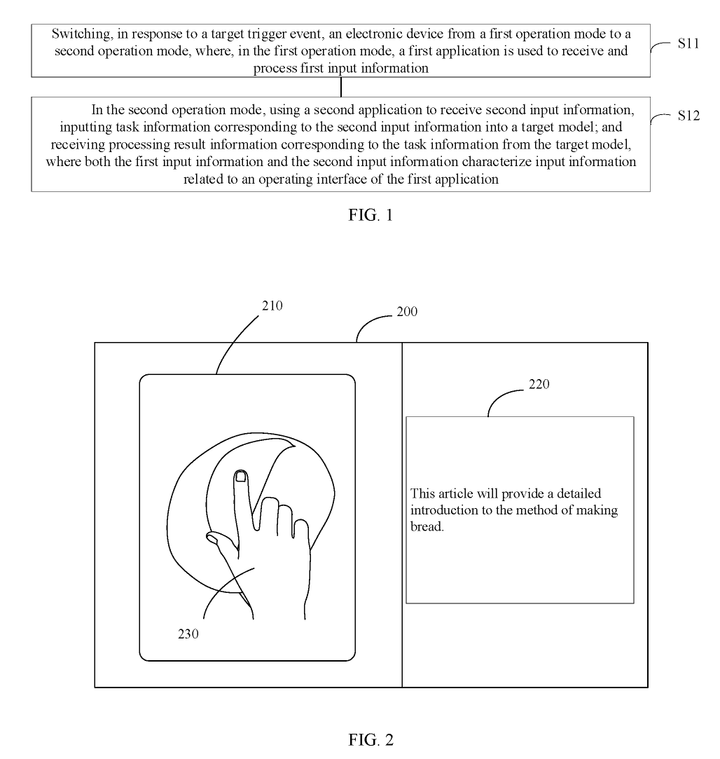

The present disclosure provides a data processing method. As shown in FIG. 1, which is a flow chart of a data processing method consistent with various embodiments of the present disclosure, in one embodiment, the method includes:
S11: in response to a target trigger event, an electronic device switches from a first operation mode to a second operation mode, where a first application is used to receive and process first input information in the first operation mode; and
S12: in the second operation mode, a second application is used to receive second input information; task information corresponding to the second input information is input into a target model; and processing result information corresponding to the task information is received from the target model.

Both the first input information and the second input information may represent input information related to an operation interface of the first application.

The target trigger event may be any type of event that triggers the electronic device to switch from the first operation mode to the second operation mode. In some embodiments, the target trigger event may be a trigger event generated based on a user operation, for example, a target trigger event generated in response to a user performing a specified action. In some other embodiments, the target trigger event may be a trigger event automatically determined by the electronic device based on user-related interaction information during the user’s interaction with the device. For example, the electronic device may obtain image processing information input by a user within an instant messaging application, and generate the target trigger event based on the image processing information.

The first application may be an application of any type currently running on the electronic device. For example, the first application may be an operating system application, an office application, a multimedia application, or the like.

The first application may be an application currently running on the electronic device; that is, the operation interface of the first application may be displayed on the display screen of the electronic device.

In some embodiments, the first application may include multiple applications. That is, the first application may include multiple applications that are currently in a running state on the electronic device and whose corresponding operation interfaces are displayed on the display screen.

In some embodiments, in a scenario where multiple applications on the electronic device are in a running state, the first application may be a foreground application among those multiple applications.

The first operation mode may be a standard operation mode of the electronic device, or a non-Artificial Intelligence (AI) mode.

The first input information may be input information obtained in the first operation mode that is related to the operation interface of the first application. The first input information may be information of any type. In some embodiments, the first input information may include interactive information entered by a user via the operation interface of the first application. For instance, the first input information may be click data, swipe trajectory data, shortcut key data, or similar inputs entered by the user into the first application’s currently operation interface. In some other embodiments, the first input information may include information transmitted to the first application by an application external to the first application.

The first application may receive and process the first input information. For example, while operating in the first operation mode, the input information directed at the first application may be captured by the first application, which then responds to the input information.

The second operation mode may be an AI mode of the electronic device. While in the second operation mode, the electronic device may utilize AI algorithms or AI models to process the input information.

The second application may be an application that receives user interactive information while operating in the second operation mode. In some embodiments, the second application may be a system-level application running natively on the electronic device.

The second input information may be input information captured in the second operation mode and associated with the operation interface of the first application. In some embodiments, the second input information may include interactive information entered by a user via the first application’s operation interface while the electronic device is in the second operation mode. For example, this second input information may include click data, swipe trajectory data, shortcut key data, image or text editing commands, or similar actions performed by the user in relation to the first application’s interface. In some other embodiments, the second input information may include information transmitted to the first application by an application external to the first application.

In some embodiments, while in the second operation mode, the display parameters of the first application’s operation interface, or the display parameters of the input information, may be updated, which allows the user to visually and intuitively perceive that the electronic device switches from the first operation mode to the second operation mode, based on the changes in the display parameters of the first application’s operation interface and the input information (for example, the display parameters of the second input information may be differ from the display parameters of the first input information).

The second application may be configured to receive the second input information. That is, while in the second operation mode, the input information related to the first application’s operation interface may no longer be sent to the first application, but may instead be sent to the second application, enabling the second application to respond to the second input information.

The task information corresponding to the second input information may be pending task information determined based on the second input information. In some embodiments, both the pending task and the processing object corresponding to that pending task may be determined based on the second input information. For example, when the second input information includes an image editing instruction, the pending task corresponding to this information may be an image editing task, and the processing object for this task may be the specific image object associated with the second input information. Similarly, when the second input information includes a text translation instruction, the pending task may be a text translation task, and the processing object for this task may be the specific text object associated with the second input information.

The second application may input the task information corresponding to the second input information into a target model, thereby utilizing the target model to execute the pending task associated with that task information.

The target model may be any model capable of processing the pending task in question. In some embodiments, the target model may be selected based on the specific task type of the pending task. For example, when the pending task is a text processing task (e.g., text translation, text expansion, summary generation, etc.), the target model may be a Large Language Model (LLM). Alternatively, when the pending task involves processing multimodal information, the target model may be a Vision-Language Model, and so forth. In some embodiments, the target model may be selected based on the computational load associated with the pending task. For example, the second application may be used to estimate the computational resources required to process the pending task. Subsequently, by comparing this estimated computational load against the computing resources of multiple worker nodes—each hosting various models, a specific target working node may be identified from among these nodes, and the model running on this target worker node may be designated as the target model.

The target model may perform model inference on the task information corresponding to the second input information and feed the model inference result back to the second application. The second application may receive this model inference result from the target model and treat it as the processing result information corresponding to the task information.

In some embodiments, when the processing result corresponding to the task information is a visual result, the second application may display the processing result. In some other embodiments, where the processing result corresponding to the task information is an audio result, the second application may invoke the electronic device’s audio output component to output the processing result.

In the data processing method provided by the present disclosure, first, in response to the target trigger event, the electronic device may switch from the first operation mode to the second operation mode. In the first operation mode, the first application may be used to receive and process the first input information. Then, in the second operation mode, the second application may be used to receive the second input information, input the task information corresponding to the second input information into the target model, and receive the processing result information corresponding to the task information from the target model. Both the first input information and the second input information may represent the input information related to the operation interface of the first application. Therefore, in the second operation mode, the second application may be utilized to receive the second input information related to the operation interface of the first application, and to invoke the target model to process the task information corresponding to the second input information, thereby obtaining the processing result information corresponding to the task information. Rapid processing of the application information displayed within the operation interface of the first application may be achieved, shortening the user’s operational path. Further, by configuring different operation modes for the electronic device and enabling the electronic device to switch from the first operation mode to the second operation mode via the target trigger event to rapidly process the application information of the first application within the second operation mode, the user’s efficiency in processing application information may be enhanced.

In some embodiments, the data processing method may further include:
S13: based on the target trigger event, determining a target processing window corresponding to the target trigger event.

The target processing window may be a display window created by the second application in response to the target trigger event. In some embodiments, the target processing window corresponding to the target trigger event may be determined based on any suitable method.

In some embodiments, the target processing window may be determined based on the effective area corresponding to the target trigger event on the display screen of the electronic device. For example, when the effective area corresponding to the target trigger event on the display screen includes a single object, the target processing window may be determined based on that single object. When the effective area corresponding to the target trigger event on the display screen includes multiple objects, the target processing window may be determined based on the entire display interface currently being output on the display screen.

In some other embodiments, the target processing window may be determined based on the type of controls corresponding to the target trigger event. For example, when the target trigger event corresponds to a first type of controls, the target processing window may be determined based on the operation interface of the electronic device’s current foreground application. When the target trigger event corresponds to a second type of controls, the target processing window may be determined based on the entire display interface currently output on the display screen.

In some embodiments, when determining the target processing window based on a partial display interface or the entire display interface on the display screen, the display position of the target processing window on the display screen may correspond to the display position of the partial or entire display interface associated with the target processing window.

Correspondingly, at S12, utilizing the second application to receive the second input information may include:
S121, utilizing the second application to receive the second input information corresponding to the target processing window.

The input information associated with the target processing window may be designated as the second input information, and the second application may be utilized to receive this second input information.

In some embodiments, after the target processing window is identified, the user may perform a scaling operation on the target processing window, thereby enabling the target processing window to be displayed using either a portion of the display area or the entire display area of the electronic device.

In some embodiments, when the target processing window is displayed using the entire display area of the electronic device’s display screen, all user interactions with the electronic device’s display interface may occur within the target processing window. Therefore, these interactions may be transmitted to the second application as the second input information. In some other embodiments, when the target processing window is displayed using only a portion of the display area, user interactions occurring within the target processing window may be transmitted to the second application as the second input information, while interactions occurring outside the target processing window (within the remaining display area) may be transmitted to the first application as the first input information.

In some embodiments, after the target processing window is identified, the display layer of the target processing window may be elevated to the foreground (placed on top), and the user may be enabled to perform a dragging operation on the target processing window, which allows the user to drag the target processing window to a suitable position, thereby minimizing the extent to which it obstructs the operation interface of the first application, and enabling the user to continue interacting with the first application seamlessly.

In the embodiments of the present disclosure, by identifying the specific target processing window corresponding to the target trigger event and utilizing the target processing window to receive the second input information intended for processing by the second application, the user may be enabled to input interactive information within different display regions according to their specific operational objectives. Furthermore, when the user utilizes the target processing window to process application-specific information originating from the first application’s operation interface, the user may remain within the contextual environment of the first application. Therefore, no extraneous jump or context-switching operations may be required, thereby facilitating in-situ processing of application information and reducing the number of steps required of the user. Also, by allowing the user to continue interacting with the underlying first application even while simultaneously manipulating the target processing window, a more flexible and enriched interactive experience may be provided to the user. In addition, because the display position of the target processing window on the screen corresponds directly to the position of the specific display region (whether partial or full) associated with the target processing window, visual jarring or disorientation for the user may be effectively prevented.

In some embodiments, the data processing method may further include at least one of S141 to S144.

At S141, the target trigger event may be generated based on a first trigger operation performed on a first control displayed on the electronic device’s display screen.

The first control may be any type of control displayed on the display screen of the electronic device. In some embodiments, the first control may be an icon-type control, an animation-type control, a floating-window-type control, or the like.

In some embodiments, the first trigger operation directed at the first control may be any type of operation preset for the first control. For example, the first trigger operation may be a tap, a long press, a swipe, or the like directed at the first control. For another example, the first trigger operation may be a voice command, a gesture command, or the like directed at the first control.

Therefore, in response to receiving the first trigger operation directed at the first control, the target trigger event corresponding to said first trigger operation may be generated.

At S142, the target trigger event may be generated based on a first gesture operation detected on a touch device, where the touch device is communicatively coupled to the electronic device.

The touch device may be any type of device communicatively coupled to the electronic device. In some embodiments, the touch device may be a device connected to the electronic device via a physical communication line, such as an external touchpad of the electronic device. In some other embodiments, the touch device may be a device connected to the electronic device via wireless communication signals, such as a device connected via Bluetooth, a mobile hotspot (Wi-Fi), or the like. In some other embodiments, the touch device may be a stylus communicatively coupled to the electronic device.

In some embodiments, the first gesture operation performed on the touch device may be any type of gesture operation executed on the touch device. In some embodiments, the first gesture operation may be a gesture operation directed at a specific location on the touch device, such as a gesture operation directed at the tail, body, or tip of a stylus. In some embodiments, the first gesture operation may be a preset gesture operation directed at a specific location on the touch device, such as a finger-tapping operation or a two-finger squeezing operation performed on the body of the stylus.

In some embodiments, when the first gesture operation includes a user squeezing the body of the stylus with two fingers, the electronic device may enter the temporary second operation mode (i.e., a temporary AI mode) while the user is squeezing the stylus body. Subsequently, in response to the user reducing the squeezing pressure applied to the stylus body, the device may exit the temporary second operation mode.

Therefore, in response to the first gesture operation performed on the touch device, the target trigger event corresponding to the first gesture operation may be generated.

At S143, the target trigger event may be generated based on a second gesture operation performed on the display screen of the electronic device.

The second gesture operation may be a gesture operation performed by a user on the display screen of the electronic device.

In some embodiments, in a scenario where the display screen is displaying the operation interfaces of multiple first applications, the second gesture operation may be a gesture operation performed by the user on one of these multiple first applications displayed on the screen.

In some embodiments, the second gesture operation may be a gesture operation performed by the user on at least one of the displayed objects on the screen. The displayed objects may include an image object, a text object, a video object, an audio object, or the like, which are displayed by the first application. In some embodiments, the second gesture operation may be a gesture operation performed by the user on the display screen along a specified trajectory. For example, the second gesture operation may be a three-finger swipe, a rectangular trajectory gesture, a circular trajectory gesture, or the like, performed by the user on the display screen.

Therefore, in response to the second gesture operation, the target trigger event corresponding to the second gesture operation may be generated.

At S144, the target trigger event may be generated based on a first stylus operation.

The first stylus operation may be any stylus operation in which the user touches the display screen of the electronic device using a specified region of the touch device.

In some embodiments, the first stylus operation may be a stylus operation performed by a user on the display screen of the electronic device using a specified region of the touch device and following a preset trajectory. For example, the first stylus operation may be a stylus operation performed by a user on the display screen using the tip of the touch device (e.g., a stylus), following a circular trajectory, a rectangular trajectory, or the like. For example, in a scenario where the touch device is a stylus, the target trigger event may be generated in response to the user touching the display screen of the electronic device using the tip of the stylus.

Therefore, in response to the first gesture operation, the target trigger event corresponding to the first stylus operation may be generated.

In some embodiments, the target trigger event may be generated based on interaction methods of different categories.

The interaction methods may be classified into different categories based on the scope of the corresponding area to be processed. The area to be processed may be the region within which the user intends to perform AI processing on the displayed application information. For example, when the area to be processed is the entire display area of the electronic device’s display screen, the corresponding interaction method may be determined to be an interaction of a first category, and when the area to be processed is only a partial region of the electronic device’s display screen, the corresponding interaction method may be determined to be an interaction method of a second category or an interaction method of a third category.

Correspondingly, determining the target processing window corresponding to the target trigger event in S13 may include at least one of S131 to S133.

At S131, when the target trigger event is generated based on the interaction method of the first category, the target processing window may be determined based on the entire display interface output by the electronic device.

As previously described, the interaction method of the first category may be interaction methods where the corresponding area to be processed is the entire region displayed on the electronic device’s display screen. Therefore, when the target trigger event is generated based on the interaction method of the first category, the target processing window corresponding to the target trigger event may be determined based on the entire display interface output by the electronic device.

In some embodiments, the interaction method of the first category may include the aforementioned first trigger operation, for example, a trigger operation directed at the first element displayed on the electronic device’s display screen.

In some embodiments, the interaction method of the first category may include the aforementioned first gesture operation directed at the touch input device, for example, a two-finger squeeze gesture applied to the body of a stylus, a two-finger tap gesture, and so forth.

In some embodiments, the interaction method of the first category may include the aforementioned second gesture operation performed by a user’s fingers upon the electronic device’s display screen, where the area to be processed corresponding to the second gesture operation includes the entire display interface output by the electronic device. For instance, the second gesture operation may include a sliding motion performed by the user using two, three, or more fingers on the display screen.

At S132, when the target triggering event is generated based on the interaction method of the second category, at least one object displayed by the electronic device may be identified; and, in response to the user’s selection operation on the first object among the at least one object, the target processing window may be determined based on the first object.

As described above, the interaction method of the second category may be interaction methods in which the corresponding area to be processed includes a partial display area within the electronic device’s display screen.

When the target triggering event is generated based on the interaction method of the second category, objects displayed on the electronic device’s screen may be first identified to determine the at least one object. The at least one object may include an image object, a text object, a video object, an audio object, or the like, situated within the operation interface of the first application. Subsequently, based on the user’s selection operation on the first object among the at least one object, the first object may be designated as the object of user interest, and the target processing window including the first object may be generated.

In some embodiments, the interaction method of the second category may include the first gesture operation on the touch device described above, for example, a two-finger pinch operation or a two-finger tap operation directed at the body of the touch device. Thus, after determining the target trigger event based on the first gesture operation, at least one object displayed within the entire display interface of the electronic device may be identified. Subsequently, based on the user’s selection operation, the first object may be selected from the at least one object, thereby determining the target processing window based on the first object.

At S133, when the target trigger event is generated based on the interaction method of the third category, a second object corresponding to the interaction method of the third category may be determined; and subsequently, the target processing window may be determined based on the second object.

As described above, the interaction method of the third category may be interaction methods where the corresponding area to be processed includes a partial display area within the electronic device’s display screen.

When the target trigger event is generated based on the interaction method of the third category, the second object may be determined based on the partial display area corresponding to the interaction method of the third category. Subsequently, the target processing window may be generated based on the second object.

In some embodiments, the interaction method of the third category may include the second gesture operation on the electronic device’s display screen described above. The second gesture operation may include gestures directed at a partial display area within the electronic device’s display screen. For example, the second gesture operation may include a user utilizing a finger to circle and select an area of interest on the display screen.

In some embodiments, the interaction method of the third category may include the first stylus operations described above, involving the use of a designated area of a touch device to interact with the electronic device’s display screen. For example, the first stylus operations may include a user utilizing a stylus to circle and select an area of interest on the display screen.

In the embodiments provided in the present disclosure, different target trigger events may be determined based on different interaction methods. Subsequently, the target processing window including different application information (i.e., different types of object information displayed within the operation interface of the first application) may be determined based on the target trigger event. The diversity and flexibility of user interaction methods may be enhanced.

In some embodiments, after determining the target processing window corresponding to the target trigger event, that is, after S13, the data processing method may further include at least one of S151 to S154.

At S151, the boundary of the target processing window may be configured to a specified first display parameter.

After identifying the target processing window, the first display parameter may be configured for the window boundary of the target processing window, thereby enabling the user to visually and intuitively perceive that the current window serves as the task processing window operating in the AI mode.

In some embodiments, the first display parameter may include one or more of a color parameter, brightness parameter, width parameter, shape parameter, or any other type of display parameters about the boundary of the target processing window.

At S152, a specified animation effect within the target processing window may be displayed.

After identifying the target processing window, the specified animation effect may be displayed within the target processing window, thereby enabling the user to visually and intuitively perceive that the current window serves as the task processing window operating in the AI mode.

In some embodiments, the animation effect may be displayed for a specified duration following the generation of the target processing window.

In some other embodiments, the animation effect may be displayed continuously throughout the entire duration that the target processing window is being displayed.

In some embodiments, the animation effect may be of any type of animation effects. For example, the animation effect may be a brightness gradient effect, a color gradient effect, or the like. It should be noted that the display of this animation effect does not interfere with the user’s interaction with the target processing window.

At S153, the display parameters of the target processing window and the operation interface of the first application may be updated separately, such that the display parameter of the target processing window differs from the display parameter of the operation interface of the first application.

After identifying the target processing window, the display parameter of both the target processing window and the operation interface of the first application may be updated separately, that is, distinct display parameters may be configured for the target processing window and the operation interface of the first application, thereby enabling the user to visually and easily distinguish the target processing window from the display interface of the first application.

In some embodiments, a higher brightness parameter may be configured for the target processing window relative to the operation interface of the first application, allowing the user to intuitively perceive that the target processing window is the currently active, top-most window.

In some embodiments, distinct color parameters may be configured for the target processing window and the operation interface of the first application, enabling the user to easily distinguish the target processing window from the display interface of the first application based on the differing color information.

At S154, the display parameter of the second input information may be configured to be a designated second display parameter, where the second display parameter differs from a third display parameter corresponding to the first input information.

After identifying the target processing window, the display parameter may be configured for the second input information received within that target processing window. This second parameter may be distinct from the third parameter corresponding to the first input information, thereby enabling the user, based on the visual presentation of the second input information, to intuitively perceive that the system is currently operating in the AI mode.

In some embodiments, the second display parameter may differ from the third display parameter in terms of brightness, line thickness, color, gradient effects, or similar attributes.

In the embodiments of the present disclosure, by configuring the specific display parameter for the target processing window, the operation interface of the first application, or the first input information and the second input information, the user may be enabled to visually and intuitively perceive that the system is currently operating in the AI mode, as well as to identify the specific boundary of the target processing window associated with that AI mode.

In some embodiments, before inputting the task information corresponding to the second input information into the target model in S12, the data processing method may further include S161 and S162.

At S161, at least one object within the target processing window may be identified.

After determining the target processing window based on the target trigger event, at least one object within the target processing window may be identified. For example, the at least one object may include a text object, an image object, a video object, an audio object, or the like, located within the operation interface of the first application.

In some embodiments, any suitable method may be utilized to identify the at least one object.

In some embodiments, identifying the at least one object within the target processing window may include: identifying at least one view control included within the target processing window; and, based on the at least one view control, obtaining the at least one object.

Here, the at least one view control may include a component used to construct a user interface, serving to facilitate the visual presentation of data and user interaction. In some embodiments, the at least one view control may include buttons, text controls, image controls, list controls, and the like.

In some embodiments, identifying the at least one view control included within the target processing window may include identifying text controls (e.g., TextView controls), image controls (e.g., ImageView controls), and the like, which are included within the target processing window.

After the at least one view control is identified, the second application may access the at least one view control and retrieve the at least one object corresponding to the at least one view control, such as, a text object, an image object, or the like.

In some other embodiments, identifying the at least one object within the target processing window may include: capturing a screenshot of the target processing window; inputting the screenshot into the target model; and receiving, from the target model, the at least one object corresponding to the screenshot.

The second application may be used to capture the screenshot of the target processing window and the screenshot may be input into the target model, thereby enabling the target model to identify the at least one object present within the screenshot. In some embodiments, the target model may be a large language model, a vision-language model, or the like.

In some other embodiments, when the second application is unable to identify the view controls within the target window, the second application may capture the screenshot of the target processing window, and the target model may be utilized to identify the at least one object present within the screenshot.

In the embodiments provided by the present disclosure, as compared to obtaining the at least one object within the target processing window by means of the screenshot, the at least one object may be obtained by identifying the at least one view control within the target processing window, which may enhance the quality of the obtained objects. For example, images possessing the same quality as the originals can be obtained, or original text can be obtained. Furthermore, in contrast to a user manually capturing the screenshot and subsequently utilizing image editing software to identify objects therein, in the present disclosure, the second application may be used to execute the screenshot capture and subsequently utilizes the target model to identify the at least one object within the captured window image. This method may streamline the operational steps required of the user, while the utilization of the target model for image recognition may simultaneously improve the accuracy with which the objects are identified.

At S162, the task information may be generated based on the second input information and the at least one object.

After identifying the at least one object within the target processing window, the second application may receive the second input information and, based upon the second input information, determine the specific task to be performed regarding the at least one object, thereby generating the task information.

In some embodiments, S162 may include S1621 to S1623.

At S1621, a third object may be determined from the at least one object, based on the second input information.

The second input information may be a selection operation directed toward the third object from the at least one object. In some embodiments, the second input information may include operations such as a click, a long press, a circling selection, or a checkbox selection, directed toward the third object.

At S1622, based on the object type of the third object, at least one second control may be displayed.

In some embodiments, the object type of the third object may include a text type, an image type, a video type, or an audio type, and so on.

One second control may be a control for editing or processing the third object. In some embodiments, one second control may be presented in the form of an icon, text, or the like.

In some embodiments, when the object type of the third object is a text type, the at least one second control may include controls for performing operations, such as translation, summarization, copying, or searching for similar text, on the third object. In some other embodiments, when the object type of the third object is an image type, the at least one second control may include controls for performing operation, such as saving, sharpening, background removal, beautification, or searching for similar images, on the third object. In some other embodiments, when the object type of the third object is an audio type, the at least one control may include controls for performing operations, such as speech recognition, noise reduction, background sound removal, or saving, on the third object.

At S1623, in response to a trigger operation performed on a target second control among the at least one second control, the task information based on the target second control and the third object may be generated.

In response to the user’s trigger operation on the target second control among the at least one second control, such as the user’s selection of the target second control, the processing or editing instruction corresponding to that target second control may be designated as a pending task, and the third object may be designated as the processing object for that pending task, thereby generating the task information corresponding to the second input information.

In the embodiments described above, the at least one second control may be displayed based on the type of the selected third object, enabling the user to utilize the at least one second control to edit or process the third object, thereby enhancing the intelligence of the data processing method with respect to the processing of different types of objects.

In some embodiments, where the target processing window is determined based on a fourth object within the operation interface of the first application, inputting the task information corresponding to the second input information into the target model in S12 may include S122 to S123.

At S122, based on the object type of the fourth object, at least one third control may be displayed.

The specific implementation of displaying the at least one third control based on the object type of the fourth object may be similar to the specific implementation of displaying the at least one second control based on the object type of the third object, as described in S1622, which will not be repeated here.

At S123, in response to a trigger operation performed on a target third control among the at least one third control, task information may be generated based on the target third control and the fourth object.

The second input information may include the trigger operation performed on the target third control among the at least one third control. Thus, in response to the user’s trigger operation on the target third control, such as the user’s selection of the target third control, the editing or processing instruction corresponding to the target third control may be designated as the instruction for the pending task, and the fourth object may be designated as the processing object corresponding to said target third control, thereby generating the task information.

In the embodiments provided by the present disclosure, when the objects within the target window include a single object (i.e., a fourth object), the second application may generate the at least one third control based on the object type of the fourth object, without requiring the user to perform a selection operation again.

In some embodiments, the second operation mode may include an inspiration album mode.

In some embodiments, while in the inspiration album mode, after identifying the target processing window including an image object, in response to the user’s circling operation on a specific region of the image, the image and the corresponding circling trajectory information may be stored into a target album. In some embodiments, the user may choose to open only the image from the target album, or to open both the image and the corresponding circling trajectory information from the target album simultaneously.

In some other embodiments, while in the inspiration album mode, after identifying the target processing window including the image object, in response to the user’s text input operation within the target processing window (performed using a stylus), the second application may be used to recognize the input text information, generate the corresponding text information at the specific location corresponding to the input operation, and store the image and the corresponding text information into a target album. In some embodiments, the user may choose to open only the image from the target album, or to open both the image and the corresponding circling trajectory information from the target album simultaneously.

In some embodiments, while in the inspiration album mode, in response to the user’s circling operation on at least two images within the aforementioned target album, at least one corresponding fourth control may be generated, and, in response to a user’s selection of a target fourth control from among the at least one fourth control, the at least two images and the target fourth control may be input into a target model as the task information, thereby utilizing the target model to execute the task information. The at least one fourth control may include operations such as image sharpening, background removal (cutout), or image blending.

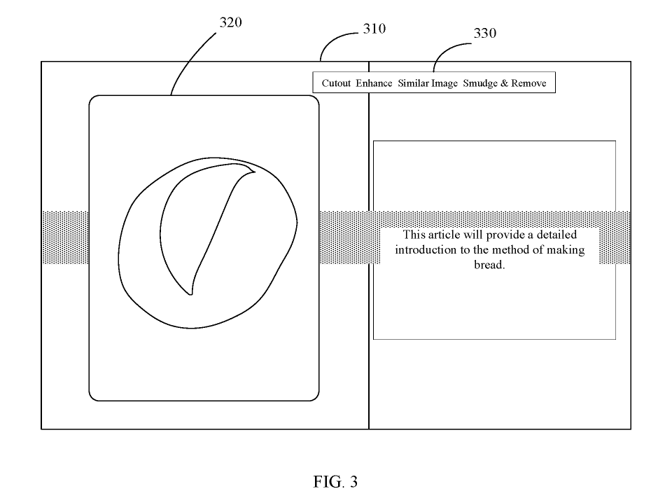

Hereinafter, an embodiment provided by the present disclosure will be described with reference to FIGS. 2 and 3.

As shown in FIG. 2, the operation interface 200 of the first application displays an image area 210 and a text area 220.

When a user wishes to perform a background removal (cutout) operation on the image displayed within the image area 210 of the operation interface 200, the user may long-press the image area 210 using their hand 230 to enter a second operation mode, that is, the AI mode.

In some embodiments, when the duration of the user’s long-press on the image area 210 is relatively short, for example, 0.5 seconds, an AI entry point may be displayed within the image area 210 to prompt the user to enter the AI mode. In response to the user triggering this AI entry point (e.g., via a tap operation), the AI mode may be entered. In some embodiments, when the operation interface 200 of the first application displays multiple images, a corresponding AI entry point may be displayed within the area occupied by each individual image in response to the user’s long-press operation.

In some embodiments, when the duration of the user’s long-press on the image area 210 is relatively long, for example, 1.5 seconds, the AI entry point may not be displayed within the image area 210. Instead, the AI mode may be entered directly.

In the AI mode, the second application may identify image objects located within the image area 210 and generate the target processing window based on the image objects. As illustrated in FIG. 3, in the AI mode, the display parameter of the first application’s operation interface 310 may differ from the display parameter of the target processing window 320. For example, the brightness of the first application’s operation interface 310 may be lower than that of the target processing window 320. Concurrently, multiple controls pertaining to the image objects within the target processing window 320 may be displayed within a floating window 330.

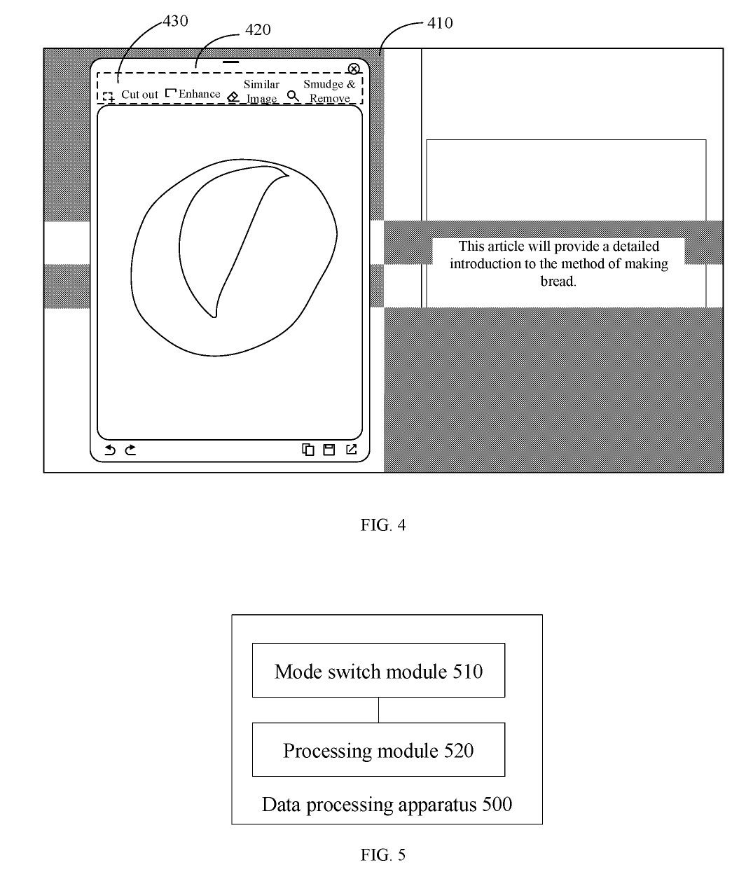

In some embodiments, the target processing window may be displayed in the manner illustrated in FIG. 4. As shown in FIG. 4, in the AI mode, the brightness of the operation interface 410 of the first application is lower than the brightness of the target processing window 420. Simultaneously, with respect to the image object displayed within the target processing window 420, multiple controls are displayed inside the target processing window 420, such as the multiple controls shown within the dashed box 430 in FIG. 4.

In response to the user’s selection operation regarding the cutout control shown in FIGS. 3-4, the second application transmits the image included in the target processing window, along with a cutout task, to a target model, enabling the target model to perform cutout processing on the image. Subsequently, the second application receives the cutout result from the target model.

In some embodiments, when the image within the target processing window includes multiple subjects (e.g., multiple persons), the target model performs cutout processing on each individual subject, thereby generating a distinct cutout result corresponding to each of the multiple subjects.

In some embodiments, when the image within the target processing window includes multiple subjects (e.g., multiple persons), a user may select a specific subject from the multiple subjects by circling it, and then tap the cutout control. The second application then may transmit the image from the target processing window, along with the trajectory information corresponding to the user’s circling action and the cutout task, to the target model, enabling the target model to perform cutout processing on the image. In this manner, the target model may perform cutout processing solely on the specific subject circled by the user.

The present disclosure also provides a data processing apparatus. The data processing apparatus may include various constituent units and modules included within those units, which may be implemented via a processor within a computing device or via specific logic circuits. The processor may be a central processing unit (CPU), a microprocessor unit (MPU), a digital signal processor (DSP), a field programmable gate array (FPGA), or a similar component. As shown in FIG. 5, which is a schematic structural diagram of a data processing apparatus provided by the present disclosure, the data processing apparatus 500 includes a mode switching module 510 and a processing module 520.

The mode switching module 510 may be configured to, in response to a target trigger event, cause an electronic device to switch from a first operation mode to a second operation mode, where, in the first operation mode, a first application is utilized to receive and process first input information.

The processing module 520 may be configured to, in the second operation mode, utilize a second application to receive second input information; input task information corresponding to the second input information into a target model; and receive, from the target model, processing result information corresponding to the task information.

Both the first input information and the second input information may represent input information related to an operation interface of the first application.

In some embodiments, the mode switching module 510 may be configured to determine a target processing window corresponding to the target trigger event, based on the target trigger event.

The processing module 520 may be configured to receive the second input information corresponding to the target processing window using the second application.

In some embodiments, the mode switching module 510 may be configured to perform at least one of:
generating the target trigger event based on a first trigger operation performed on a first control displayed on the display screen of the electronic device;
generating the target trigger event based on a first gesture operation obtained from a touch device, where the touch device is communicatively coupled to the electronic device;
generating the target trigger event based on a second gesture operation performed on the display screen of the electronic device; or
generating the target trigger event based on a first stylus operation performed by touching the display screen of the electronic device using a designated area of the touch device.

In some embodiments, the target trigger event may be generated based on interaction methods of different categories, and the processing module 520 may be configured to perform one or more of:
when the target trigger event is generated based on an interaction method of a first category, determining the target processing window based on the entire display interface output by the electronic device;
when the target trigger event is generated based on an interaction method of a second category, identifying at least one object displayed on the electronic device, and, in response to a user selection operation performed on a first object among the at least one object, determining the target processing window based on the first object; or
when the target trigger event is generated based on an interaction method of a third category, determining a second object corresponding to the interaction method of the third category, and determining the target processing window based on the second object.

In some embodiments, the processing module 520 may be configured to perform at least one of:
configuring the boundary of the target processing window to have a designated first display parameter;
displaying a designated animation effect within the target processing window;
separately updating the display parameters of the target processing window and the operation interface of the first application, such that the display parameter of the target processing window differs from the display parameter of the operation interface of the first application; or
configuring the display parameter of the second input information to have a designated second display parameter, where the second display parameter differs from a third display parameter corresponding to the first input information.

In some embodiments, the processing module 520 may be configured to:
identifying at least one object within the target processing window; and
generating the task information based on the second input information and the at least one object.

In some embodiments, the processing module 520 may be configured to perform at least one of:
identifying at least one view control included within the target processing window; and,
based on the at least one view control, obtaining the at least one object, where the object includes at least one of a text object, an image object, a video object, or an audio object; or
obtaining a screenshot of the window corresponding to the target processing window; inputting the window screenshot into the target model; and receiving, from the target model, the at least one object corresponding to the window screenshot.

In some embodiments, the processing module 520 may be configured to:
based on the second input information, determine a third object from the at least one object;
based on the object type of the third object, displaying at least one second control; and
in response to a trigger operation performed on a target second control among the at least one second control, generating the task information based on the target second control and the third object.

In some embodiments, when the target processing window is determined based on a fourth object within the operation interface of the first application, the processing module 520 may be configured to:
based on the object type of the fourth object, displaying at least one third control; and
in response to a trigger operation performed on a target third control among the at least one third control, generating the task information based on the target third control and the fourth object.

The description of the apparatus embodiments presented above is analogous to the description of the method embodiments presented above, and yields beneficial effects similar to those of the method embodiments. In some embodiments, the functions performed by, or the modules included within, the apparatus provided in the embodiments of the present disclosure may be utilized to execute the methods described in the aforementioned method embodiments. For technical details not explicitly disclosed in the apparatus embodiments of the present disclosure, reference may be made to the descriptions of the method embodiments of the present disclosure for understanding.

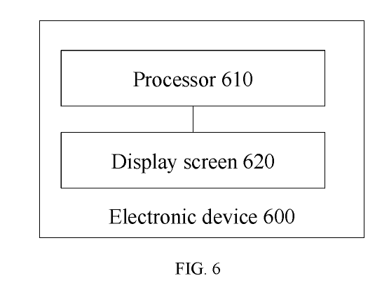

The present disclosure also provides an electronic device. As shown in FIG. 6, in one embodiment, the electronic device 600 includes a processor 610 and a display screen 620.

The processor 610 may be configured to, in response to a target trigger event, switch the electronic device from a first operation mode to a second operation mode. In the first operation mode, a first application may be utilized to receive and process first input information. In the second operation mode, a second application may be utilized to receive second input information, input task information corresponding to the second input information into a target model, and receive processing result information corresponding to the task information from the target model. Both the first input information and the second input information may characterize input information related to an operation interface of the first application;

The display screen 620 may be configured to display the processing result information.

The description of the device embodiments presented above is analogous to the description of the method embodiments presented above, and yields beneficial effects similar to those of the method embodiments. In some embodiments, the functions performed by, or the modules included within, the device provided in the embodiments of the present disclosure may be utilized to execute the methods described in the aforementioned method embodiments. For technical details not explicitly disclosed in the device embodiments of the present disclosure, reference may be made to the descriptions of the method embodiments of the present disclosure for understanding.

It should be noted that, in the embodiments of the present disclosure, when the aforementioned data processing methods are implemented in the form of software functional modules and sold or used as independent products, they may also be stored in a computer-readable storage medium. Based on this understanding, the technical solutions of the embodiments of the present disclosure, or the parts thereof that essentially contribute to the related art, may be embodied in the form of a software product. This software product may be stored in a storage medium and may include a plurality of instructions configured to enable a computing device (which may be a personal computer, a server, a network device, etc.) to execute all or part of the methods described in the various embodiments of the present disclosure. The aforementioned storage medium may include various media capable of storing program code, such as USB flash drives, portable hard drives, Read Only Memory (ROM), magnetic disks, or optical discs. Thus, the embodiments of the present disclosure are not limited to any specific hardware, software, or firmware, nor to any combination thereof.

The present disclosure also provides a computing device including a memory and a processor. The memory may be configured to store a computer program executable on the processor, and when the processor executes the program, some or all of the steps of the aforementioned methods may be implemented.

The present disclosure also provides a computer-readable storage medium having a computer program stored thereon. When the computer program is executed by a processor, some or all of the steps of the aforementioned methods may be implemented. The computer-readable storage medium may be transitory or non-transitory.

The present disclosure also provides a computer including computer-readable code. When the computer-readable code is executed within a computing device, a processor within the computing device may be configured to perform operations to implement some or all of the steps of the aforementioned methods.

The present disclosure also provides a computer program product. The computer program product may include a non-transitory computer-readable storage medium having a computer program stored thereon. When the computer program is read and executed by a computer, some or all of the steps of the aforementioned methods may be implemented. This computer program product may be specifically implemented via hardware, software, or a combination thereof. In some embodiments, the computer program product may be embodied as a computer storage medium. In some other embodiments, the computer program product may be embodied as a software product, such as a Software Development Kit (SDK), etc.

It should be noted here that the descriptions of the various embodiments provided above tend to emphasize the differences between the respective embodiments. Their identical or similar aspects may be cross-referenced. The descriptions of the embodiments regarding the aforementioned device, storage medium, computer program, and computer program product are analogous to the descriptions of the aforementioned method embodiments, and yield beneficial effects similar to those of the method embodiments. For technical details not explicitly disclosed in the embodiments regarding the device, storage medium, computer program, and computer program product of the present disclosure, reference may be made to the descriptions of the method embodiments of the present disclosure for understanding.

It should be understood that references throughout the specification to “one embodiment” or “an embodiment” mean that a particular feature, structure, or characteristic described in connection with the embodiment is included in at least one embodiment of the present disclosure. Thus, appearances of the phrases “in one embodiment” or “in an embodiment” throughout the specification do not necessarily all refer to the same embodiment. Furthermore, these particular features, structures, or characteristics may be combined in any suitable manner in one or more embodiments. It should be understood that, in various embodiments of the present disclosure, the numerical order assigned to the aforementioned steps or processes does not imply a specific chronological sequence of execution. Rather, the execution order of the steps or processes may be determined based on their respective functions and inherent logic, and should not be construed as imposing any limitation on the implementation process of the embodiments described herein. The numerical designations assigned to the embodiments in the present disclosure are provided solely for descriptive purposes and do not reflect any relative superiority or inferiority among the embodiments.

It should be noted that, as used herein, the terms “comprising,” “including,” or any other variations thereof are intended to cover non-exclusive inclusion, such that a process, method, article, or apparatus that includes a list of elements does not merely include those elements, but may also include other elements not expressly listed, or elements that are inherent to such a process, method, article, or apparatus. Unless expressly stated otherwise, an element defined by the phrase “including a...” does not exclude the presence of other identical elements within the process, method, article, or apparatus that including the said element.

In the various embodiments of the present disclosure, it should be understood that the disclosed devices and methods may be implemented in alternative ways. The device embodiments described above are illustrative in nature. For example, the division of units described herein is merely a logical functional division, and in actual implementation, alternative divisions may be adopted. For example, multiple units or components may be combined or integrated into another system, or certain features may be omitted or left unexecuted. Furthermore, the coupling (whether direct or indirect) or communication connections between the various components shown or discussed herein may be established via various interfaces. For example, the indirect coupling or connections between devices or units may be electrical, mechanical, or of other forms.

The units described above as separate components may or may not be physically distinct entities. Similarly, the components depicted as units may or may not correspond to physical units. These units may be co-located in a single physical location or distributed across multiple network units. Depending on actual requirements, a subset or all of these units may be selected to achieve the objectives of the embodiments described herein.

Additionally, in the various embodiments of the present disclosure, the functional units described may be fully integrated into a single processing unit. Alternatively, each unit may be implemented as a standalone entity; or, two or more units may be integrated into a single combined unit. Such integrated units may be implemented in the form of hardware, or in the form of a combination of hardware and software-based functional units. Those skilled in the art will understand that all or part of the steps involved in the method embodiments described above may be implemented through hardware driven by program instructions. The aforementioned programs may be stored on a computer-readable storage medium. When executed, these programs may perform the steps of the method embodiments described above. The aforementioned storage media may include various types of media capable of storing program code, such as removable storage devices, Read-Only Memory (ROM), magnetic disks, or optical discs.

Alternatively, when the integrated units described in the present disclosure are implemented in the form of software functional modules, and are sold or utilized as standalone products, they may also be stored on a computer-readable storage medium. Based on this understanding, the technical solution of the present disclosure, or its essential aspects or the portions that contribute to the relevant technology, may be embodied as a software product. This computer software product may be stored on a storage medium and may include a set of instructions configured to cause a computing device (such as a personal computer, server, or network device) to execute all or part of the methods described in the various embodiments of the present disclosure. The aforementioned storage media may include various types of media capable of storing program code, such as removable storage devices, ROM, magnetic disks, or optical discs.

The embodiments of the present disclosure have been described above. However, these embodiments are for illustrative purposes only and are not intended to limit the scope of the present disclosure. Although various embodiments have been described above, this does not mean that the measures in the various embodiments cannot be used advantageously in combination. Various substitutions and modifications may be made by those skilled in the art without departing from the scope of the present disclosure, and all such substitutions and modifications should fall within the scope of the present disclosure.

What is claimed is:

1. A data processing method comprising:
switching, in response to a target trigger event, an electronic device from a first operation mode to a second operation mode, a first application being used to receive and process first input information in the first operation mode; and
in the second operation mode, using a second application to receive second input information, inputting task information corresponding to the second input information into a target model, and receiving processing result information corresponding to the task information from the target model;
wherein the first input information and the second input information characterize input information related to an operation interface of the first application.

2. The method according to claim 1, further comprising:
generating the target trigger event based on at least one of:
a trigger operation performed on a control displayed on a display screen of the electronic device,
a first gesture operation performed on a touch device communicatively coupled to the electronic device,
a second gesture operation performed on the display screen of the electronic device; or
a stylus operation involving touching the display screen of the electronic device with a designated area of the touch device.

3. The method according to claim 1, further comprising:
determining, based on the target triggering event, a target processing window corresponding to the target triggering event;
wherein using the second application to receive the second input information includes using the second application to receive the second input information corresponding to the target processing window.

4. The method according to claim 3, wherein:
the target trigger event is generated based on an interaction method of a first category, and determining the target processing window includes determining the target processing window based on an entire display interface output by the electronic device;
the target trigger event is generated based on an interaction method of a second category, and determining the target processing window includes identifying at least one object displayed by the electronic device, and, in response to a user selection operation on a first object among the at least one object, determining the target processing window based on the first object; and/or
the target trigger event is generated based on an interaction method of a third category, and determining the target processing window includes determining a second object corresponding to the interaction method of the third category, and determining the target processing window based on the second object.

5. The method according to claim 4, wherein:
the target processing window is determined based on a third object within the operation interface of the first application; and
the method further comprises, before inputting the task information into the target model:
displaying at least one control based on an object type of the third object; and
in response to a trigger operation performed on a target control among the at least one control, generating the task information based on the target control and the third object.

6. The method according to claim 3, further comprising at least one of:
configuring a boundary of the target processing window to a first display parameter;
displaying an animation effect within the target processing window;
separately updating a display parameter of the target processing window and a display parameter of the operation interface of the first application, such that the display parameter of the target processing window differs from the display parameter of the operation interface of the first application; or
configuring a display parameter of the second input information to a second display parameter different from a third display parameter corresponding to the first input information.

7. The method according to claim 3, further comprising, before inputting the task information to the target model:
identifying at least one object within the target processing window; and
generating the task information based on the second input information and the at least one object.

8. The method according to claim 7, wherein identifying the at least one object within the target processing window includes at least one of:
identifying at least one view control within the target processing window, and obtaining the at least one object based on the at least one view control, the at least one object including at least one of a text object, an image object, a video object, or an audio object; or
obtaining a window screenshot corresponding to the target processing window, inputting the window screenshot into the target model, and receiving, from the target model, the at least one object corresponding to the window screenshot.

9. The method according to claim 7, wherein generating the task information based on the second input information and the at least one object includes:
determining, based on the second input information, one object from the at least one object;
displaying, based on an object type of the one object, at least one control; and
in response to a trigger operation performed on a target control among the at least one control, generating the task information based on the target control and the one object.

10. An electronic device, comprising:
a processor configured to:
switch, in response to a target trigger event, the electronic device from a first operation mode to a second operation mode, a first application being used to receive and process first input information in the first operation mode; and
in the second operation mode, use a second application to receive second input information, input task information corresponding to the second input information into a target model, and receive processing result information corresponding to the task information from the target model;
wherein the first input information and the second input information characterize input information related to an operation interface of the first application; and
a display screen configured to display the processing result information.

11. The electronic device according to claim 10, wherein the processor is further configured to generate the target trigger event based on at least one of:
a trigger operation performed on a control displayed on a display screen of the electronic device,
a first gesture operation performed on a touch device communicatively coupled to the electronic device,
a second gesture operation performed on the display screen of the electronic device; or
a stylus operation involving touching the display screen of the electronic device with a designated area of the touch device.

12. The electronic device according to claim 10, wherein the processor is further configured to:
determine, based on the target triggering event, a target processing window corresponding to the target triggering event; and
use the second application to receive the second input information corresponding to the target processing window.

13. The electronic device according to claim 12, wherein:
the target trigger event is generated based on an interaction method of a first category, and determining the target processing window includes determining the target processing window based on an entire display interface output by the electronic device;
the target trigger event is generated based on an interaction method of a second category, and determining the target processing window includes identifying at least one object displayed by the electronic device, and, in response to a user selection operation on a first object among the at least one object, determining the target processing window based on the first object; and/or
the target trigger event is generated based on an interaction method of a third category, and determining the target processing window includes determining a second object corresponding to the interaction method of the third category, and determining the target processing window based on the second object.

14. The electronic device according to claim 13, wherein:
the target processing window is determined based on a third object within the operation interface of the first application; and
the processor is further configured to, before inputting the task information into the target model:
control the display screen to display at least one control based on an object type of the third object; and
in response to a trigger operation performed on a target control among the at least one control, generate the task information based on the target control and the third object.

15. The electronic device according to claim 12, wherein the processor is further configured to perform at least one of:
configuring a boundary of the target processing window to a first display parameter;
displaying an animation effect within the target processing window;
separately updating a display parameter of the target processing window and a display parameter of the operation interface of the first application, such that the display parameter of the target processing window differs from the display parameter of the operation interface of the first application; or
configuring a display parameter of the second input information to a second display parameter different from a third display parameter corresponding to the first input information.

16. The electronic device according to claim 12, wherein the processor is further configured to, before inputting the task information to the target model:
identify at least one object within the target processing window; and
generate the task information based on the second input information and the at least one object.

17. The electronic device according to claim 16, wherein the processor is further configured to, when identifying the at least one object within the target processing window, perform at least one of:
identifying at least one view control within the target processing window, and obtaining the at least one object based on the at least one view control, the at least one object including at least one of a text object, an image object, a video object, or an audio object; or
obtaining a window screenshot corresponding to the target processing window, inputting the window screenshot into the target model, and receiving, from the target model, the at least one object corresponding to the window screenshot.

18. The electronic device according to claim 16, wherein the processor is further configured to, when generating the task information based on the second input information and the at least one object:
determine, based on the second input information, one object from the at least one object;
control the display screen to display, based on an object type of the one object, at least one control; and
in response to a trigger operation performed on a target control among the at least one control, generate the task information based on the target control and the one object.

19. A non-transitory computer-readable storage medium storing instructions that, when executed by a processor, cause an electronic device including the processor to:
switch, in response to a target trigger event, from a first operation mode to a second operation mode, a first application being used to receive and process first input information in the first operation mode; and
in the second operation mode, use a second application to receive second input information, input task information corresponding to the second input information into a target model, and receive processing result information corresponding to the task information from the target model;
wherein the first input information and the second input information characterize input information related to an operation interface of the first application.

20. The storage medium according to claim 19, wherein the instructions, when executed by a processor, further cause the electronic device to generate the target trigger event based on at least one of:
a trigger operation performed on a control displayed on a display screen of the electronic device,
a first gesture operation performed on a touch device communicatively coupled to the electronic device,
a second gesture operation performed on the display screen of the electronic device; or
a stylus operation involving touching the display screen of the electronic device with a designated area of the touch device.
